(19) United States
(12) Patent Application Publication
(10) Pub. No.: US 2013/0162604 A1
(43) Pub. Date: Jun. 27, 2013

(54) ELECTROMAGNETIC PEN

(71) Applicants: XIAO-YANG WANG, Shenzhen City (CN); SHIH-TSAI LIU, Tu-Cheng (TW)

(72) Inventors: XIAO-YANG WANG, Shenzhen City (CN); SHIH-TSAI LIU, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/597,234

(22) Filed: Aug. 28, 2012

(30) Foreign Application Priority Data
Dec. 22, 2011 (CN) 201110435101.8

(51) Int. Cl. G06F 3/033

(52) U.S. Cl. 345/179; 178/19.01

(57) ABSTRACT

An electromagnetic pen includes a pen core body, an outer cladding surrounding the pen core body, an oscillator circuit and a battery. The outer cladding is made of insulative material. A number of elongated first conductors and a number of elongated second conductors are alternately arranged on a circumferential surface of the outer cladding, and each first conductor is electrically insulated from the corresponding neighboring second conductors. Each first conductor is electrically coupled to the battery, and each second conductor is electrically coupled to the oscillator circuit. When the electromagnetic pen is held by a user, the first conductor is electrically connected to the second conductor via the user's hand, causing the battery to provide voltage to the oscillator circuit, and the oscillator circuit therefore emits electromagnetic signals.

### BACKGROUND

1. Technical Field

The present disclosure relates to electromagnetic pens, particularly, to an electromagnetic pen that can automatically emit electromagnetic signals when being held by a user.

2. Description of Related Art

Active electromagnetic pens usually need a battery to provide power to an oscillator circuit. However, some of the active electromagnetic pens are always in a working state when being used, which will consume a lot of power. Some of the active electromagnetic pens have a switch allowing a user to turn on or turn off the active electromagnetic pen. This requires the user to manually operate the switch, which is inconvenient.

Therefore, an electromagnetic pen to resolve the problems mentioned above is needed.

### BRIEF DESCRIPTION OF THE DRAWINGS

Many aspects of the embodiments can be better understood with reference to the following drawings. The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is a schematic view of an electromagnetic pen according to a first embodiment.

FIG. 2 is a right side view of the electromagnetic pen of FIG. 1.

FIG. 3 is a schematic view of an electromagnetic pen according to a second embodiment.

FIG. 4 is a schematic view of an electromagnetic pen according to a third embodiment.

FIG. 5 is a schematic diagram showing a battery and an oscillator circuit that are respectively connected to a first conductive rubber layer and a second conductive rubber layer of the electromagnetic pen of FIG. 1.

### DETAILED DESCRIPTION

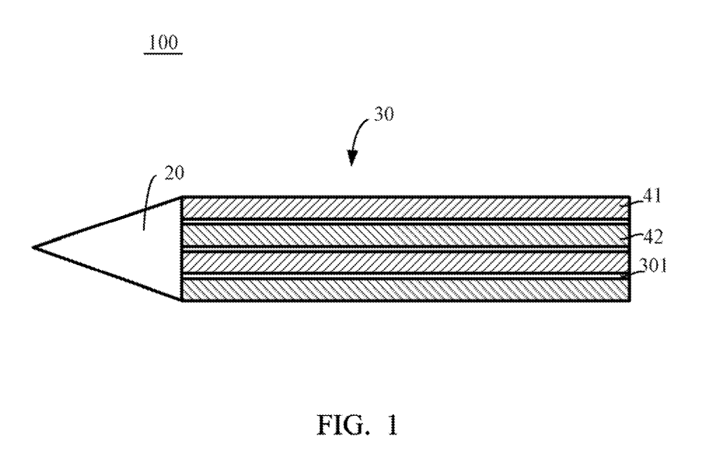

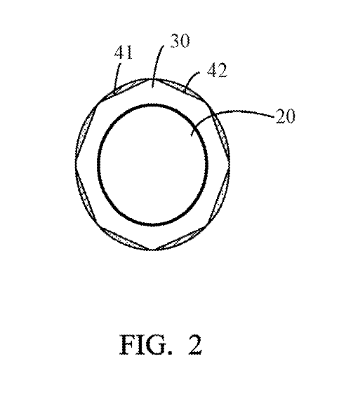

Referring to FIGS. 1 and 2, an electromagnetic pen 100 is disclosed according to an embodiment. The electromagnetic pen 100 includes a pen core body 20 and a outer cladding 30 surrounding the pen core body. The outer cladding 30 is made of electrically insulative material. A number of elongated first conductors 41 and a number of elongated second conductors 42 are alternately arranged on a circumferential surface of the outer cladding 30. In the embodiment, each first conductor 41 is a first conductive rubber layer having nice tactile qualities, and each second conductor 42 is a second conductive rubber layer having nice tactile qualities.

In the embodiment, each of the first conductive rubber layers 41 are electrically insulated from the corresponding neighboring second conductive rubber layers 42.

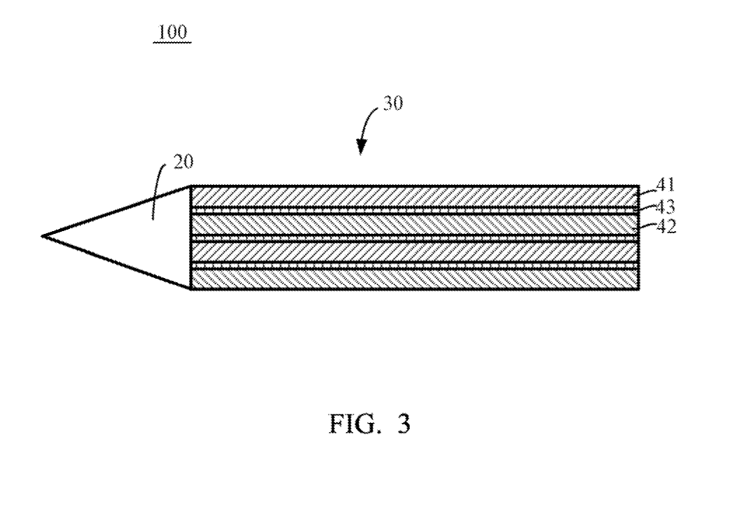

In the embodiment, the outer cladding 30 includes a plurality of exposed portions 301 separating the first conductive rubber layers 41 from the second conductive rubber layers 42. In another embodiment, referring to FIG. 3, an insulating material 43 may be arranged between each two neighboring first conductive rubber layer 41 and second conductive rubber layer 42.

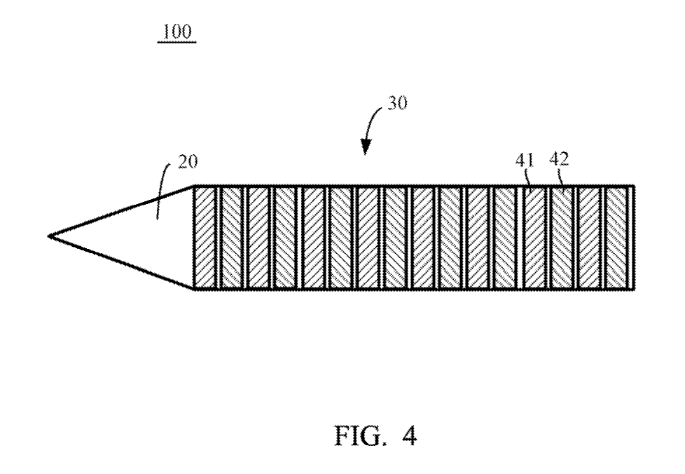

In the embodiment, both of the first conductive rubber layers 41 and the second conductive rubber layers 42 extend along the lengthwise direction of the pen core body 20, which will be touched and held by a user. In another embodiment, referring to FIG. 4, both of the first conductive rubber layers 41 and the second conductive rubber layers 42 may be extend along a circumferential direction of the outer cladding 30, which will be touched and held by a user. It should be noted that, the conductive rubber layers 41 and 42 can be set to have different colors or patterns, such that the electromagnetic pen 100 can have an esthetic appearance.

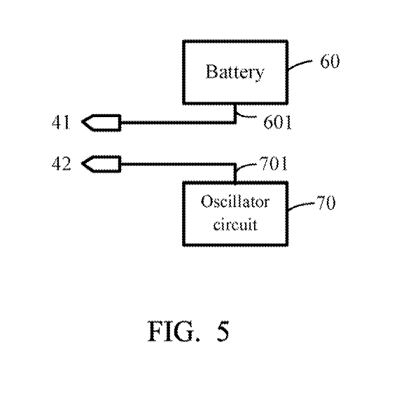

Referring to FIG. 5, the electromagnetic pen 100 further includes a battery 60 and an oscillator circuit 70 positioned in the internal of the outer cladding 30. The oscillator circuit is used for emitting electromagnetic signals, and the battery 60 provides power to the oscillator circuit 70. In the embodiment, each of the first conductive rubber layers 41 is electrically coupled to a voltage output port 601 of the battery 60, and each of the second conductive rubber layers 42 is electrically coupled to a voltage input port 701 of the oscillator circuit 70. When a user holds the electromagnetic pen 100, the user's hand will electrically connect the first conductive rubber layer 41 to the second conductive rubber layer 42. The battery 60 then provides voltage to the oscillator circuit 70 through the voltage input port 701 via the first conductive rubber layer 41, the user's hand, and the second conductive rubber layer 42. The oscillator circuit 70 then continually emits electromagnetic signals that will be received and processed by an electronic device, such as a tablet computer. The electromagnetic pen 100 can then be used as an input device to input information to the electronic device. When the user puts down the electromagnetic pen 100, the first conductive rubber layer 41 is electrically disconnected from the second conductive rubber layer 42. The oscillator circuit 70 is therefore disconnected from the battery 60, and stops emitting electromagnetic signals, which will cause the active electromagnetic pen 100 to enter into a standby mode, with no power consumed.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electromagnetic pen comprising:
a pen core body;
an outer cladding surrounding the pen core body, the outer cladding made of electrically insulative material;
a plurality of elongated first conductors and a plurality of elongated second conductors alternately arranged on a circumferential surface of the outer cladding, each of the first conductors being electrically insulated from the corresponding neighboring second conductors;
an oscillator circuit configured to emit electromagnetic signals, the oscillator circuit comprising a voltage input port; and
a battery configured to provide power to the oscillator circuit, the battery comprising a voltage output port;
wherein, each of the first conductors is electrically coupled to the voltage output port of the battery, and each of the second conductors is electrically coupled to the voltage input port of the oscillator circuit; and
when the electromagnetic pen is held by a user, the first conductor is electrically connected to the second conductor via the user's hand, causing the battery to provide voltage to the oscillator circuit through the voltage input port, and the oscillator circuit therefore emits electromagnetic signals.

2. The electromagnetic pen of claim 1, wherein each first conductor is a first conductive rubber layer, and each second conductor is a second conductive rubber layer.

3. The electromagnetic pen of claim 2, wherein the outer cladding includes a plurality of exposed portions separating the first conductors from the second conductors.

4. The electromagnetic pen of claim 2, wherein an insulating material is arranged between each two neighboring first conductor and second conductor.

5. The electromagnetic pen of claim 2, wherein both of the first conductors and the second conductors extend along the lengthwise direction of the pen core body.

6. The electromagnetic pen of claim 2, wherein both of the first conductors and the second conductors extend along a circumferential direction of the outer cladding.
